(19) United States
(12) Patent Application Publication
(10) Pub. No.: US 2016/0055464 A1
(43) Pub. Date: Feb. 25, 2016

(54) MONITORING CASH HANDLING MACHINES

(71) Applicant: GLORY GLOBAL SOLUTIONS (INTERNATIONAL) LIMITED, Basingstoke Hampshire (GB)

(72) Inventors: Bryan James CHRISTOPHERSEN, Basingstoke, Hampshire (GB); James William LONG, Basingstoke, Hampshire (GB)

(73) Assignee: GLORY GLOBAL SOLUTIONS (INTERNATIONAL) LIMITED, Basingstoke, Hampshire (GB)

(21) Appl. No.: 14/780,585

(22) PCT Filed: Mar. 28, 2014
(86) PCT No.: PCT/EP2014/056360

§ 371 Date: Sep. 28, 2015

(30) Foreign Application Priority Data
Mar. 28, 2013 (GB) 1305719.5

(51) Int. Cl. G06Q 20/10

(52) U.S. Cl. CPC G06Q 20/1085

(57) ABSTRACT

A banking system comprising a network, one or more cash handling machines connected to the network, the cash handling machine generating a status report on detection of a status update event, at least one monitoring device connected to the network to which the status report is addressed, and one or more user devices connected to the network. The monitoring device(s) allow at least one operative of each user device to subscribe to particular cash handling machine(s) and/or particular event type(s). The at least one monitoring device receives the status reports and filters them based on one or more report identifiers in each report identifying the cash handling machine generating the report and/or an event type, and transmits to each of the user devices only the filtered status reports which contain report identifiers identifying the one or more cash handling machines and/or event types to which an operative has subscribed.

### FIELD OF THE INVENTION

The present invention relates to cash handling machines in a banking system, such as teller cash dispensers, teller cash acceptors, teller cash recyclers, or automatic teller machines (ATMs) and to monitoring such cash handling machines.

### BACKGROUND

It is an important requirement to monitor the status of such cash handling machines, because they can be vital in a continued efficient operation of a bank. Cash handling machines can run out of money or develop other mechanical or software faults. At present, a manager or other monitoring operative is provided with a monitoring console which is connected to the cash handling machines for which he is responsible and allows him to access a status report from each cash handling machine at his monitoring console. The monitoring console polls the cash handling machines for updates and compiles them into such a status report.

### SUMMARY

According to one aspect of the present invention, there is provided a cash handling machine for use in a banking system, the machine comprising: a cash handling mechanism for handling physical documents or tokens pertaining to monetary value to implement at least in part a customer facing transaction; a controller executing an embedded application for monitoring the status of the cash handling mechanism and arranged to generate a status report on detection of a status update event, the status report addressed to at least one monitoring device; and a network port connected to receive a status report from the controller for transmitting the report to the at least one monitoring device.

Embodiments of the invention described in the following solve a range of technical difficulties associated with the known technique for monitoring the status of cash handling machines. One difficulty is that a manager or monitoring operative is restricted to a predetermined set of machines which are polled by the console at which he is working. Furthermore, all reports for that set of machines are received at his console, resulting in a large amount of information, much of which may not be appropriate to the task that the particular manager or other monitoring operative has to carry out. Moreover, because a manager needs to instigate access of a status report from a cash handling machine, it requires effort for him to review and he may miss critical intervening events at the cash handling machine which he then identifies too late, or later than desirable to run an effective efficient banking system.

The status reports can include a machine identifier which uniquely identifies the cash handling machine and/or an event-type identifier which uniquely identifies the type of event. The event-type identifier can distinguish between different types of event.

Advantageously, the status reports are “pushed” from the cash handling machine when the status update event is detected. When the status reports allow the machine or event type to be identified, they can be filtered at the monitoring device and made available only to “subscribers” who have subscribed to a particular machine or event type. This allows a manager or other monitoring operative to be presented only with information which is germane to the task that he has to perform. For example, a manager may be interested only in inventory-related matters at the cash handling machine (cash amounts, transactions, etc.), while a technician may be interested only in mechanical faults which develop at the cash handling machine, and will not be interested in the financial transactions conducted at the machine.

The event can be an operational event, including but not limited to a maximum amount of cash in the machine, a minimum amount of cash in the machine or the fact that the machine is empty. Alternatively, the events can be diagnostic events relating to the functionality of the cash handling machine (for example, mechanical faults), or controller-related events which can pertain to operation of the controller and/or the requirement for software updates, for example. Another type of event is a time-based event, which collects data in a certain time period and provides a report including that data at the end of the time period.

The term “cash handling machine” used herein is intended to denote any machine whose primary function is to deliver at least in part customer facing transactions. While a cash handling machine is principally capable of handling cash components in the form of note and coins, it is also capable of handling other physical or tangible documents, such as invoices, cheques, and bills. In the context, the term “cash handling mechanism” is intended to cover any physical mechanism capable of handling any of the preceding physical components. Cash handling machines include, but are not restricted to, teller cash dispensers, acceptors or recyclers and ATMs.

Another aspect of the present invention provides a monitoring device for use in a banking system, the monitoring device comprising: a network port for connecting the device to a network and configured to receive status reports from a plurality of cash handling machines connected to the network; a filter function for receiving a subscription message from an operative at a user device via the network port and configured to select filter settings for filtering incoming status reports based on one or more report identifier identified in the subscription message; and a control function for transmitting to the user device, via the network port, only status reports based on the filter settings for that operative.

Preferably, the reports are displayed at the request (for example, log-in) of the operative. Each user device can be operated by one or more operative. Each operative has an associated subscription such that when that operative logs in the reports to which he has subscribed are available to him. The user device can take the form of a monitoring console which forms part of the monitoring device or which can be networked to the monitoring device. The monitoring device can be a server with its own monitoring console. Alternatively, as in the described embodiment, a server connected to a plurality of individual user devices. In the latter case, the filter settings can be adjusted for each operative at each user device and separately stored at the server.

A user device can be in the form of a workstation or a mobile device such as a tablet or other computing device. The bank network can be wired or wireless.

Another aspect of the present invention provides a method of reporting events in a cash handling machine used in a banking system, the method comprising at the cash handling machine: monitoring a cash handling mechanism for handling physical documents or tokens pertaining to monetary value; detecting a status update event relating to the cash handling mechanism and generating a status report addressed to at least one monitoring device, the status report identifying the status update event; and transmitting the status report to the least one monitoring device. It is advantageous if the report is transmitted (pushed) when the status update event is detected.

A further aspect of the invention provides a method of monitoring operation of a plurality of cash handling machines connected to a network in a banking system, the method comprising: receiving from each of the cash handling machines, status reports identifying status update events detected at the cash handling machines; filtering the status report based on a report identifier in each report to provide to a user device only filtered status reports containing report identifiers to which an operative of the user device has subscribed; and displaying the filtered status reports at the user device.

Where the report identifier is a machine identifier, this allows a group of machines from the plurality to be monitored by a particular operative at a particular user device, without having to receive information from machines in which he is not interested.

The group of machines can be in a single branch (i.e., a single premises), or in multiple branches in a single region. Alternatively, an overall banking supervisor could receive status reports on all machines in his scope of responsibility, e.g. geographical location, regardless of branch or region.

Another aspect of the invention provides a method of monitoring operation of a group of cash handling machines connected to a network in a banking system, the method comprising: receiving from each of a plurality of the cash handling machines, including said group but not restricted to said group, status reports identifying status update events detected at the cash handling machine; filtering the status report based on a machine identifier in each report to provide to a user device, status reports only from the group of machines to which an operative of the user device has subscribed; and displaying the filtered status reports at the user device.

The described embodiments of the invention provide the possibility for selected monitoring by an operative of cash handling machines at any granularity of machine or type of event. They can even be used to allow the machines to be monitored outside the particular banking enterprise. For example, service providers may wish to monitor mechanical faults of certain selected machines, and cash in transit (CIT) companies may be interested to monitor the cash status of particular machines for which they are responsible.

A further aspect of the invention provides a computer program product comprising program code means which when executed by a processor in a cash handling machine monitor the status of a cash handling mechanism of the cash handling machine and generate a status report on detection of a status update event, the status report addressed to at least one monitoring device.

The invention further provides a banking system comprising: a network; at least one cash handling machine connected to the network, the cash handling machine arranged to generate a status report on detection of a status update event related to operation of the cash handling machine; at least one monitoring device connected to the network to which the status report is addressed and configured to receive the status report and to filter status reports based on a report identifier in each report; and at least one user device connected to the network for receiving filtered status reports which contain report identifiers to which an operative of the user device has subscribed.

It is expected that in most banking environments, the communication of the status update reports will be secure, that is in the context of a secured network. However, in situations where the reports are required outside the enterprise, unsecured communication of the reports could be provided. In one embodiment, the status update reports could be transmitted (broadcast) over the public Internet. In that context where unsecured communication is inappropriate, communication could be limited at the user device for access only by particular subscribers and/or encrypted so that their meaning is only decrypted at the user device.

For a better understanding of embodiments of the present invention and to show how they may be put into effect, reference is made to the accompanying drawings:

### BRIEF DESCRIPTION OF THE DRAWINGS

FIG. 1 is a schematic diagram of a banking system;

FIG. 2 is a schematic diagram of teller equipment;

FIG. 3 is a schematic diagram of further teller equipment;

FIG. 4 is a block diagram of a cash handling machine; and

FIG. 5 is a block diagram of a monitoring device.

### DETAILED DESCRIPTION OF PREFERRED EMBODIMENTS

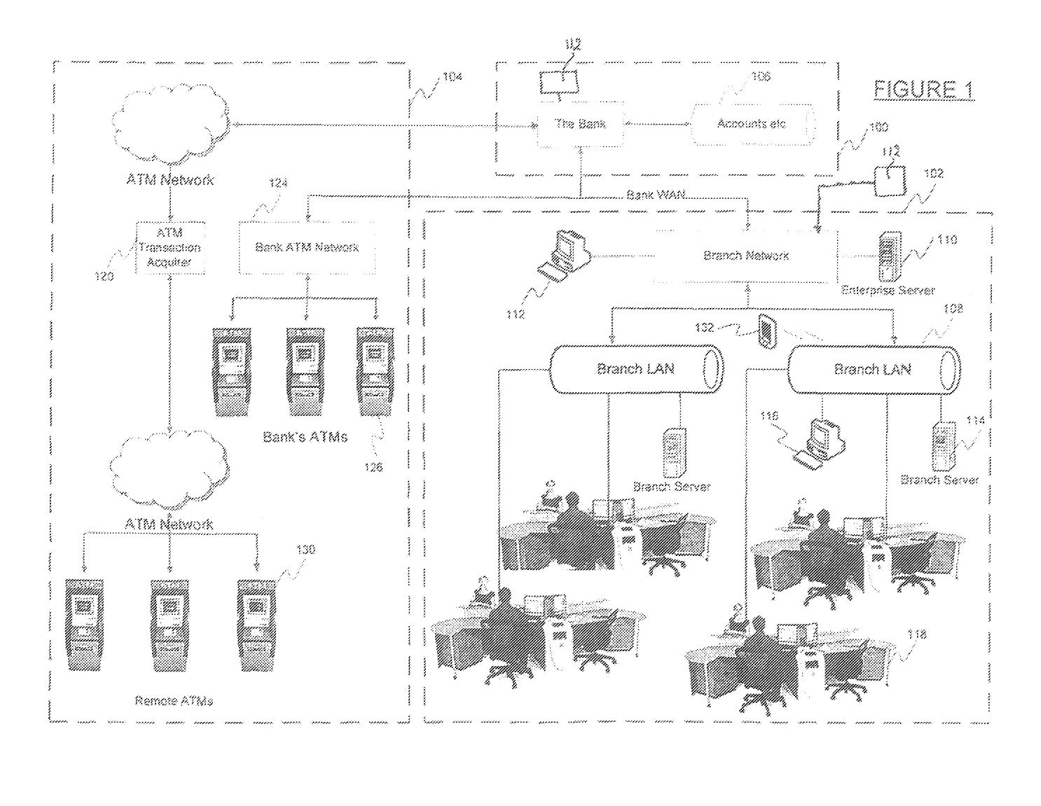

FIG. 1 provides a schematised illustration of a banking environment. This comprises a core system 100 of the bank, a branch banking network 102, and an ATM network 104. The described embodiment is particularly useful in the context of a retail banking environment. A retail bank has at least some customer facing functions located in premises which a customer visits to carry out a customer based transaction.

The core system 100 comprises a database 106 which is where the records for all the customers of the bank are stored, including the account data for each customer defining the monetary value of the account and potentially other factors such as a credit or overdraft limit. Any transaction such as those involving dispensing cash to a customer, accepting deposit of cash from a customer, transferring funds between accounts, paying bills or loaning funds to a customer's account must be cleared by the core network 100 and recorded in the database 106 of the core system 100.

The branch banking network 102 is connected to the core system 100 by a wide area network (WAN) of the bank. The branch banking network 102 is the part of the banking environment relating to the interface between branch staff and customers. Within the branch banking network 102 for the whole bank enterprise, each individual branch comprises a respective local area network (LAN) 108. Each branch's LAN 108 comprises a branch server 114 and teller equipment 118 for one or more tellers.

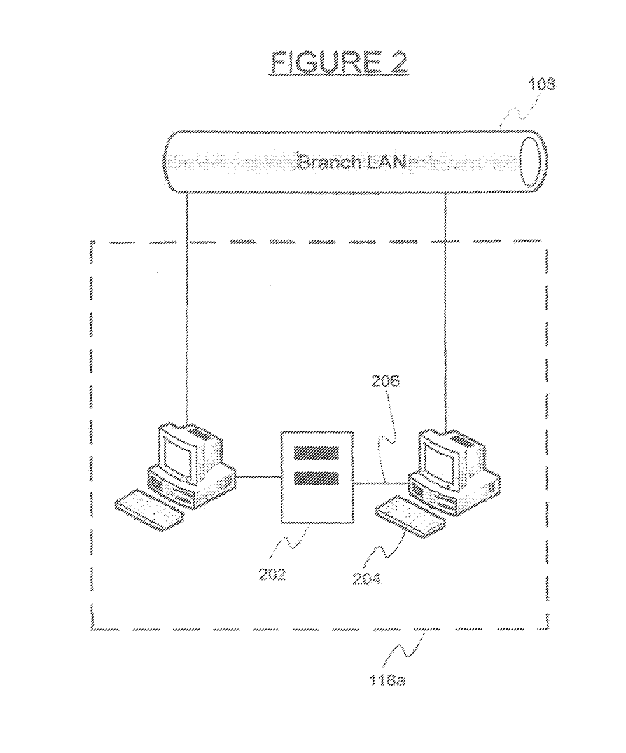

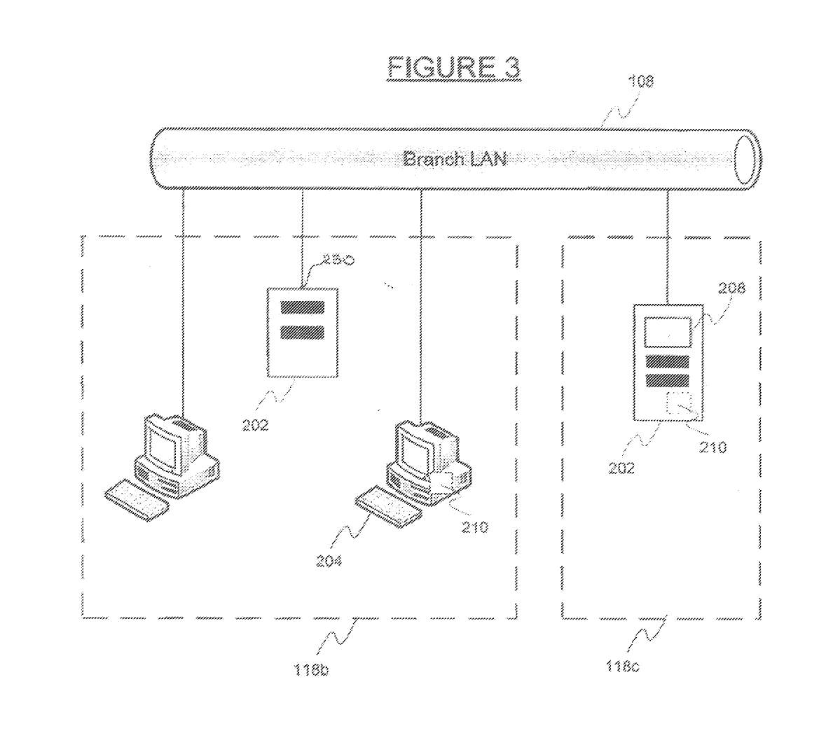

FIGS. 2 and 3 give schematic block diagrams showing examples of teller equipment 118.

The teller equipment 118 comprises one or more cash-handling machines 202, e.g. in the form of a teller cash dispenser (TCD), teller cash acceptor (TCA) and/or teller cash recycler (TCR). Each cash-handling machine 202 comprises a secure cash box and a mechanism for dispensing and/or accepting cash.

FIG. 2 shows a more traditional arrangement 118a for the teller equipment 118, where the cash-handling machine 202 comprises a conventional TCD, TCA or TCR without its own user interface. In this case the user interface is provided by a separate terminal in the form of a teller workstation 204. In the traditional set-up each cash-handling machine 202 is connected to only one or at most two teller workstations 204, and is strictly a peripheral of its one or two respective work stations 204, each connection being a direct, dedicated, one-to-one physical connection 206 in the form of a cable such as a serial cable. The cash-handling machine is not connected to any other part of the network 102, 100 by any other connection and is strictly isolated from the wider network 102, 100.

FIG. 3 shows an alternative arrangement 118b and/or 118c for the teller equipment 118, which shifts away from the workstation centric model of FIG. 2 towards a more branch-wide or even enterprise-wide model. In this case each cash-handling machine 202 comprises a network port connecting directly onto the branch LAN 108 without needing to be connected immediately to a teller workstation 204 (even though the workstation 204 may still be physically adjacent). The cash-handling machine 202 is now a network addressable device rather than a peripheral of a workstation 204, the machine 202 having its own network address and being configured to communicate according to a suitable network protocol such as TCP-IP.

In one example 118b of such an arrangement, the cash-handling machine 202 still does not have its own user interface and the workstation 204 is arranged to communicate with the cash-handling machine 202 via the branch LAN 108 in order to conduct transactions such as dispensing and/or accepting cash, paying bills, etc. In embodiments, some or all of the software for operating the cash-handling machine 202 may be hosted on the branch server 114, or even an enterprise server 110 of the wider branch-banking network 102. This software may be accessed using an application in the form of a computer program resident on the workstation 204.

The branch LAN 108 may also comprise one or more further branch terminals 116 other than a teller workstation 204, not immediately located next to a cash-handling machine 202. For instance this may be a supervisor's terminal, a terminal of a manager's office or a terminal in a separate client meeting room. In the network model, a further branch terminal 116 like this may also be enabled to access functionality of the cash-handling machines 202. Similarly, connected to the wider branch banking network 102 but not necessarily associated with any single branch, the branch banking network 102 may further comprise one or more terminals 112 such as a terminal of a regional manager's office or a headquarters. Again such terminals 112 may be enabled to access functionality of the cash-handling machines 202 in one or more of the various branches via the branch banking network 102.

For example, the network model may provide wider visibility of inventory (how much cash is in which cash-handling machines 202). A teller, supervisor or manager having branch-wide or regional responsibility may be able to view inventory of a plurality of different cash-handling machines 202 in one or more branches via the network 114 or 102 using one of the further terminals 116 or 112 or work stations 204. This enables a more intelligent management of inventory, as the user can see a wider picture of which machines 202 are low on cash and which are relatively full, and plan the movement of cash between them in a more efficient given visibility of this information over the network. That is, it may be used to reduce delivery or collections to/from the machines.

A further possible use is to provide diagnostic or maintenance related information, e.g. a technician may monitor the status of cash-handling machine remotely from an external terminal 112. This may enable the technician to arrive at the branch more prepared for the required maintenance (e.g. taking the right tools) or even perform a remote recovery for some faults.

In another example arrangement 118c, the cash-handling machine 202 has its own user interface 208 integrated into the same terminal (in the same housing) allowing it to be operated directly. An example of this is a teller assisted machine, which is partially (but not fully) self-service. The customer can initiate or perform part of a transaction him or herself, but a teller is still available on the branch floor to assist in the transaction. In this case one of the users may be a customer as opposed to a member of bank staff as in the other examples above.

Again some or all of the software may be hosted on a server 110 or 114, but this time accessed via a resident application running on the teller assisted machine 118c itself rather than a separate workstation 204. Also, the inventory and/or diagnostic or maintenance information for this machine 118c may again be made visible to other terminals 112, 116 or 204.

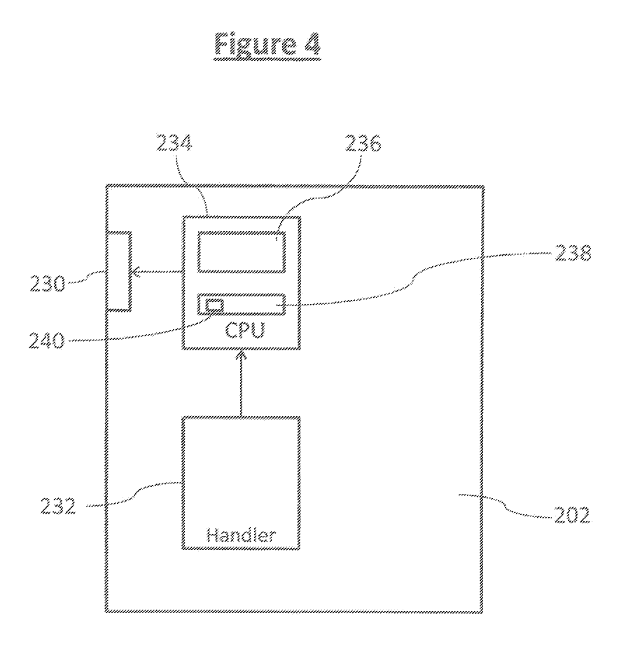

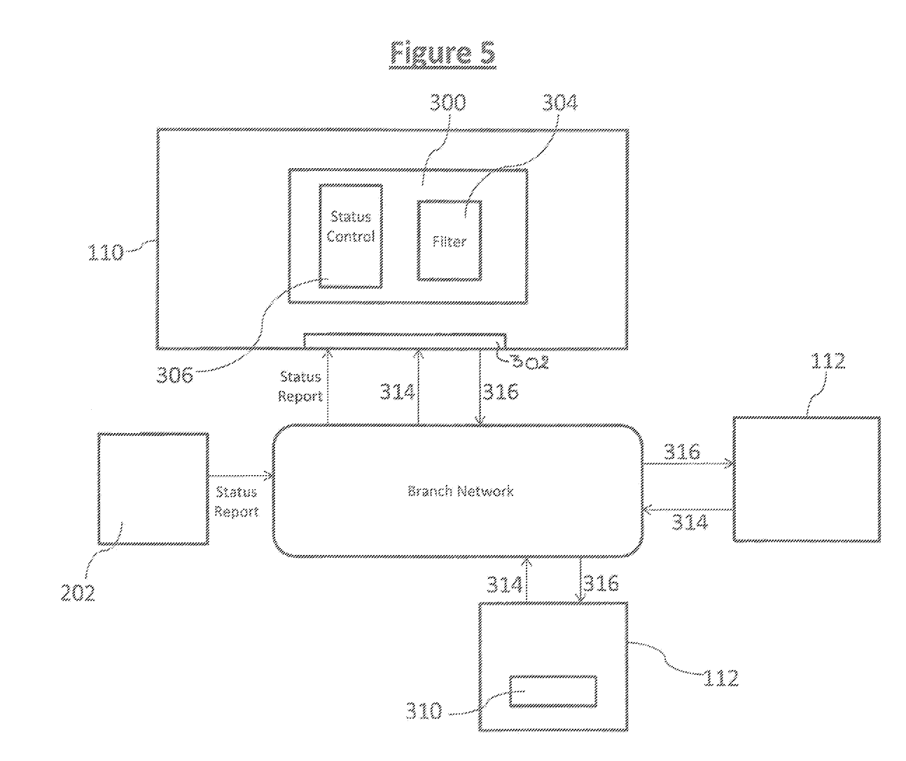

In another example, a mobile user terminal such as a smart phone, tablet or laptop may be able to access some functionality of the system via a suitable wireless connection with the LAN 108 or wider network 102, e.g. to access inventory or diagnostic information in a manner to be discussed in more detail with reference to FIGS. 4 and 5.

The ATM network 104 is a separate, distinct system to the branch banking network 102. The ATM network 104 comprises a constituent ATM network 124 of the bank comprising a plurality of ATMs (automatic teller machines) 128 of that bank, and a constituent ATM network 128 of one or more other banks comprising a plurality of ATMs 130 of those one or more other banks.

Even in the case where the teller equipment 118 takes the form of a teller assisted machine 118c, this is not an ATM. Firstly, the teller equipment 118 is equipment that involves an interaction between a member of bank staff (a human teller) and the customer, and is never entirely self-service. Secondly, any transaction performed through the branch banking network relates to an account with that particular bank, i.e. that particular enterprise. In contrast, a user does not need to have an account with a given bank to use the ATM of that bank. To this end the ATM network 104 comprises an ATM transaction acquirer 120 to couple between the core system 100 of the bank and the core system(s) of the one or more other banks, and are arranged to perform the relevant interaction to dispense cash from the ATM of one enterprise and deduct from the account of another enterprise. Conversely, a user of an ATM can only access one (his own) account. An ATM does not give visibility into any other accounts. On the other hand, an ATM cannot reach other accounts than that of the customer operating it (typically only the account associated with the card with which the ATM is presented), whereas a teller assigned machine would allow some operators like a teller or supervisor to access many different accounts of other users (multiple customers' accounts). Further, the branch banking network 102 and ATM network 104 operate on different protocols.

In the present context, the term “cash handling machine” extends to include but are not restricted to teller operated, teller assisted machines and customer self-service machines such as ATMs.

FIG. 4 illustrates one embodiment of a teller cash handling machine 202 as a schematic block diagram. The machine 202 comprises a handling mechanism denoted handler 232. The handling mechanism performs the function of mechanically (that is tangibly or physically) handling the physical documents or tokens representing cash value which the machine dispenses and accepts. As already mentioned herein, these documents can be cash notes, or can be bills, invoices or other documents representing monetary value. The tokens representing monetary value can be coins. The cash handling mechanism 232 contains a number of mechanical components. One function of the mechanical component is to receive documents and tokens. Another function is to dispense cash and documents such as receipts. Some functions are under the operation of a controller 234. The machine includes a storage zone for notes and coins. One important operating status parameter is the amount of cash in the machine. The controller is responsive to instructions from a teller for controlling operation of the machine 202. The controller is in the form of a central processing unit 234 which comprises a processor 236 and memory 238 which stores code executed by the processor to implement the operations of the CPU. Distinct from known cash handling machines, the machine 202 of the present embodiment holds in the memory 238 an embedded application 240 which acts as a local embedded application to monitor the operations of the cash handling machine. The embedded application 240 autonomously pushes status reports from the cash handling machine 202 to the network 101 via a network port 230. The status reports are event driven. That is, a status report is pushed on detection of defined events occurring in the cash handling mechanism 232. Events to be monitored may also include operations of the controller 234 itself.

Events in the cash handling machine can include an event that a certain lower or upper limit of cash has been reached; that the cash store is empty; that there is a fault, etc. A CPU-related event may be that the software which runs the operation of the cash handling machine requires an update.

Another type of event is a “time-based” event. According to this event, data is collected from the machine over a certain time period and then compiled into a status report at the end of that time period. For example, the transaction rate of the machine can be collected to determine usage in certain periods, including certain times of day. Alternatively, changes in an inventory can be logged in a certain time period.

Status reports are sent from the machine 202 addressed in accordance with the TCP/IP protocol. Any other suitable network protocol is possible, and the network could be wired or wireless. In some embodiments it is a private secure network because the machines are used in a banking environment. In other embodiments, the Internet can be used. The status reports can be addressed to a single server, a specific group of servers or broadcast to all servers over the network. The server can be the branch server 114 or enterprise server 110. FIG. 5 is a schematic block diagram of a monitoring device in the form of a server 110. The server comprises a central controller in the form of a CPU 300 which is connected to a network interface 302 which connects the server 110 to the network. The CPU 300 includes a processor and memory which holds code for execution by the processor to implement the functions of the CPU. Normal server functions are implemented at the server illustrated in FIG. 5, but are not described further herein. Relevant herein however is that the CPU 300 provides a filter function 304 and a status control function 306. The server 118 is connected to one or more user devices, such as 112,116 for example. Alternatively, mobile user terminals can act as the user devices. Each user device has an interface 308 which incorporates a display 310 which displays status reports to a user as provided by the control function 306 in a manner to be explained. The user interface also incorporates normal user interface input means, such as a keyboard, touchscreen, etc., allowing a user at the server to control its operation as described more fully herein.

As shown in FIG. 1, the user device such as terminals 112, 116 are connected to the server 114, 110 at the network interface 302 via the branch network or branch LAN so that multiple monitoring devices can operate from the same server. Each user device is intended to be operated by an operative responsible for monitoring the status of the machines 202 which are under his general control. The operative could be responsible for all machines in a single branch, all machines in a single region or all machines across a banking environment for a particular bank (enterprise). An operative can “subscribe” to receive status reports only from certain machines. To do so, he/she selects a set of events they are interested in at the UI 308 by inputting data defining events of interest, events being identified by different categories of identifiers. A subscription message 314 is created by the console including identifiers of events to which the operative has subscribed and sent to the server 110 or 114. The filter function receives the message 314 and associates the event identifiers with the operative. When a status report defining a new event is received at the server, the control function 304 checks the association to see what operatives have subscribed to the event. The control function formulates a status update report 316 for the user devices requiring that event. While the server may receive status reports from all cash handling machines 202, the filter function 304 provides to the control function 304 the status of only those machines to which the operative associated with that particular server (or monitoring device) has subscribed. To this end, each machine 202 has a machine identifier which allows the filter function to identify the particular machines of interest to which the operative has subscribed.

Additionally or alternatively, operatives can subscribe to receiving status reports only for particular types of events. To that end, each event carries a type identifier which denotes the type of event and allows the filter function to present only those types of event to which the operative has subscribed.

Thus, the filter function can implement a plurality of different filters so different operatives can subscribe to different updates, for example, based on location. For example a branch manager could subscribe to updates from the branch and the sub-branch, while a regional manager subscribes to all updates within a region, or based on the type of update (for example, technical faults or machine too empty or too full of cash). Requests can be sent from the server when updates are received from machines, or can be despatched at certain intervals. Each report returned to the user device contains only status updates subscribed to by the operative at the user device. Each user device can be operated by one or more operative. Each operative has an associated subscription such that when that operative logs in the reports to which he has subscribed are available to him.

When an operative logs on, he has access to historic reports which have been received with the identifiers of interest to him. That is, he can access a history associated with a particular report identifier as well as receiving new reports tagged to the same identifier.

The embodiment described above in which reports are transmitted from the machines when the event of interest is detected (so-called “pushed”), is particularly advantageous because it allows events at a machine to be available to an operative who is monitoring the machine in real time should the operative choose to do so. The operative can intervene quickly and effectively when he receives notification of the event. Moreover, he is not overwhelmed with data from machines for which he is not responsible, or from or by events which he is not interested in because he can subscribe only to those events of particular relevance to the role that he has to perform.

Nevertheless, an advantage can still be gained in a scenario where events are not necessarily pushed from the machines in real time. For example, they could be sent from the machines periodically at certain times of day or at certain periods.

It will be appreciated that the above embodiments have been described only by way of example. Other variants may be implemented by a person skilled in the art given the disclosure herein. The scope of the invention is not limited by the described embodiments but only by the accompanying claims.

1. A banking system comprising:
a network;
one or more cash handling machines connected to the network, the cash handling machine arranged to generate a status report on detection of a status update event related to operation of the cash handling machine;
at least one monitoring device connected to the network to which the status report is addressed; and
one or more user devices connected to the network;
wherein the at least one monitoring device is arranged such that at least one operative of each user device can subscribe to a particular one or more of said cash handling machines and/or a particular one or more event types; and
wherein the at least one monitoring device is configured to receive the status reports and to filter the status reports based on one or more report identifiers in each report identifying the cash handling machine generating the report and/or an event type, and to transmit to each of the user devices only the filtered status reports which contain report identifiers identifying the one or more cash handling machines and/or event types to which an operative of the user terminal has subscribed.

2. A banking system according to claim 1, wherein each of the one or more cash handling machines comprises:
a cash handling mechanism for handling physical documents or tokens pertaining to monetary value to implement a customer facing transaction;
a controller executing an embedded application for monitoring the status of the cash handling mechanism and arranged to generate the status report on detection of the status update event, the status report addressed to the at least one monitoring device; and
a network port connected to receive the status report from the controller for transmitting the report to the at least one monitoring device.

3. A banking system according to claim 2, wherein the network port is configured to transmit the report when the status update event is detected.

4. A banking system according to claim 2, wherein:
each of the one or more cash handling machines is provided with a unique machine identifier, and the one or more report identifiers comprise the machine identifier;
the at least one operative of each user device can subscribe to a particular one or more of said cash handling machines; and
the at least one monitoring device is configured to filter the status reports based on the machine identifier in each report identifying the cash handling machine generating the report, and to transmit to each user device only the filtered status reports where the machine identifier identifies the one or more cash handling machines to which an operative of the user terminal has subscribed.

5. A banking system according to claim 2, in which a plurality of different types of status update events can be detected, wherein:
the one or more report identifiers comprise an event-type identifier which identifies the type of the event included in the status report;
the at least one operative of each user device can subscribe to a particular one or more of said event types; and
the at least one monitoring device is configured to filter the status reports based on the event-type identifier in each report identifying the event type, and to transmit to each user device only the filtered status reports where the event-type identifier identifies the one or more event types to which an operative of the user terminal has subscribed.

6. A banking system according to claim 2, wherein the status update events include one or more of the following types:
operational events including a minimum amount of cash remains in the machine,
a maximum amount of cash is in the machine, and
the machine is empty of cash;
diagnostic events pertaining to the mechanical functioning of the cash handling mechanism;
events pertaining to the controller; and
time based events.

7. A monitoring device for use in a banking system, the monitoring device comprising:
a network port for connecting the device to a network and configured to receive status reports from a plurality of cash handling machines connected to the network;
a filter function for receiving a subscription message from an operative at a user device via the network port and configured to select filter settings for filtering incoming status reports based on one or more report identifier identified in the subscription message; and
a control function for transmitting to the user device, via the network port, only status reports based on the filter settings for the operative at that user device.

8. A monitoring device according to claim 7, wherein the report identifier uniquely identifies a particular cash handling machine in a plurality of machines.

9. A monitoring device according to claim 7, wherein the report identifier uniquely identifies a type of status update event included in a status report.

10. A monitoring device according to claim 7, configured to display the status reports at the user device: at the request of an operative at the user device; periodically; or when the report is received at the monitoring device.

11. A method of monitoring operation of a plurality of cash handling machines connected to a network in a banking system, the method comprising:
receiving from each of the cash handling machines, status reports identifying status update events detected at the cash handling machines;
filtering the status report based on a report identifier in each report to provide to a user device only filtered status reports containing report identifiers to which an operative of the user device has subscribed; and
displaying the filtered status reports at the user device.

12. A method of monitoring operation of a group of cash handling machines connected to a network in a banking system, the method comprising:
receiving from each of a plurality of the cash handling machines, including said group but not restricted to said group, status reports identifying status update events detected at the cash handling machine;
filtering the status report based on a machine identifier in each report to provide to a user device, status reports only from the group of machines to which an operative of the user device has subscribed; and
displaying the filtered status reports at the user device.

13. A method according to claim 12, wherein the report identifier is a machine identifier which identifies cash handling machine whereby an operative can monitor a selected group of machines from the plurality.

14. A method according to claim 12, wherein the group of machines is in a single branch of a bank.

15. A method according to claim 13, wherein the group of machines comprise machines in multiple branches in a region.

16. A method according to claim 12, wherein the step of filtering is further carried out based on report identifiers which are event-type identifiers in the status reports.

17. A computer program product comprising program code embodied on a computer-readable storage medium, which when executed by a processor in a monitoring device performs the method of claim 11.

18. A banking system according to claim 1 wherein the filtered status reports which contain report identifiers identifying the one or more case handling machines and/or event types to which an operative of the user terminal has subscribed are available when that operative logs in to the banking system.

19. A monitoring device according to claim 7, wherein the status reports based on the filter settings for the operative at that user device are available when that operative logs in to the banking system.

20. A method according to claim 11, wherein the filtered status reports are available to the operative at the user device when that operative logs in to the banking system.

21. A method according to claim 12, wherein the filtered status reports are available to the operative at the user device when that operative logs in to the banking system.
